(19) United States
(12) Patent Application Publication
(10) Pub. No.: US 2013/0329034 A1
(43) Pub. Date: Dec. 12, 2013

(54) DEFOCUS AMOUNT ESTIMATION METHOD, IMAGING APPARATUS, AND TRANSPARENT MEMBER

(71) Applicant: CANON KABUSHIKI KAISHA, Tokyo (JP)

(72) Inventors: Akira Eguchi, Utsunomiya-shi (JP); Yoshinari Higaki, Tokyo (JP)

(21) Appl. No.: 13/909,376

(22) Filed: Jun. 4, 2013

(30) Foreign Application Priority Data
Jun. 7, 2012 (JP) 2012-130104

(51) Int. Cl. G06T 7/00; G02B 21/34

(52) U.S. Cl. CPC G06T 7/0012; G02B 21/34
USPC 348/79; 382/128

(57) ABSTRACT

A defocus amount estimation method for an imaging apparatus that captures, using an image sensor, an image of a specimen formed by an imaging optical system includes a captured image evaluation step of fixing the specimen using a transparent member including a mark that applies at least one of a phase variation and an amplitude change to transmitted light, to acquire a captured image containing an image of the specimen and an image of the mark, and an estimation step of estimating a defocus amount based on the captured image.

### BACKGROUND OF THE INVENTION

1. Field of the Invention

The present disclosure relates to a method for estimating a defocus amount occurring when an imaging apparatus captures an image.

2. Description of the Related Art

In recent years, a pathological diagnosis support system referred to as a virtual slide system has attracted attention in the medical field. In the virtual slide system, a virtual slide (i.e., a digital imaging apparatus) captures an image of a specimen to be observed, so that a digital image is acquired. The system is thus capable of providing a new method of diagnosis, such as remote diagnosis and automatic diagnosis, which has not been able to realize by using a conventional microscope. Further, a high-resolution image of an entire observation area of the specimen (e.g., a stained body tissue) is required in performing pathological diagnosis. It is thus necessary for the virtual slide to acquire a high-quality image with a broad field of view.

In a general pathologic diagnosis, a prepared slide in which the specimen is covered and fixed by a transparent member (i.e., a cover glass) is used. However, there is unpredictable waviness in the specimen and the cover glass, so that defocusing occurs differently for each prepared slide, or depending on the imaging position even in the same prepared slide. Further, defocusing occurs due to a temperature change or a mechanical error. Accordingly, it becomes necessary to estimate the defocus amount at each imaging position and correct defocusing in the entire observation area to acquire a high-resolution image with abroad field of view for performing pathological diagnosis.

U.S. Patent Application Publication No. 2002/0021434 and U.S. Patent Application Publication No. 2005/0112475 discuss, as a method for estimating the defocus amount in a semiconductor exposure apparatus, a method using image intensity distribution of a mask having an asymmetrical diffraction grating. More specifically, U.S. Patent Application Publication No. 2002/0021434 discusses a method using a test mask having an asymmetrical diffraction grating pattern. Since the image of the asymmetrical diffraction grating pattern horizontally shifts in proportion to the defocus amount, the defocus amount is quantified by measuring the shift amount. Further, U.S. Patent Application Publication No. 2005/0112475 discusses a method of, by disposing the asymmetrical diffraction grating on a mask substrate used for manufacturing, calculating the defocus amount from a relation between the position of a projected image and the position of a wafer.

However, since U.S. Patent Application Publication No. 2002/0021434 discusses the method of estimating the defocus amount using a test mask different from the mask used for manufacturing, it becomes necessary to separately perform exposure for the focus estimation and exposure for manufacturing. In other words, the test specimen and the prepared slide are separately imaged even when the method discussed in U.S. Patent Application Publication No. 2002/0021434 is applied to the virtual slide. Thus, the defocus amount caused by the waviness in the specimen and the cover glass cannot be estimated. Further, the asymmetrical diffraction grating discussed in U.S. Patent Application Publication No. 2005/0112475 is arranged at a position on the mask substrate different from a device pattern to be exposed. Thus, the defocus amount in the device pattern surface cannot be estimated with the unpredictable waviness taken into account. Therefore, in the virtual slide, it is difficult to estimate the defocus amount with consideration of the waviness within the observation area of the prepared slide, even when using the methods discussed in U.S. Patent Application Publication No. 2002/0021434 or 2005/0112475.

### SUMMARY OF THE INVENTION

An embodiment of the present invention is directed to an imaging apparatus that estimates a defocus amount caused by waviness of a specimen to acquire an image of the specimen.

According to an aspect of the present invention, a defocus amount estimation method for an imaging apparatus that captures, using an image sensor, an image of a specimen formed by an imaging optical system includes a captured image evaluation step of fixing the specimen using a transparent member including a mark that applies at least one of a phase variation and an amplitude change to transmitted light, to acquire a captured image containing an image of the specimen and an image of the mark, and an estimation step of estimating a defocus amount based on the captured image.

Further features and aspects of the present invention will become apparent from the following description of exemplary embodiments with reference to the attached drawings.

### BRIEF DESCRIPTION OF THE DRAWINGS

FIG. 1 is a schematic diagram illustrating an imaging apparatus (i.e., a virtual slide) according to an exemplary embodiment of the present invention.

FIG. 2 is a schematic diagram illustrating a prepared slide.

FIG. 3A is a schematic diagram illustrating a phase variation applied by a cover glass to transmitted light, and

FIG. 3B is a schematic diagram illustrating an amplitude change applied by the cover glass to the transmitted light.

FIG. 4 is a cross-sectional view illustrating the cover glass.

FIG. 5 illustrates intensity transmittance of the specimen.

FIG. 6 illustrates through-focus images of the prepared slide.

FIG. 7 is a flowchart illustrating an evaluation amount calculation process.

FIG. 8 illustrates a method for dividing the image.

FIGS. 9A and 9B illustrate the change in evaluation value with respect to an image plane defocus amount.

FIG. 10 illustrates the through-focus images of the prepared slide after recovering the image.

FIG. 11 illustrates the through-focus images of the prepared slide using the cover glass without marks.

FIG. 12 is a flowchart illustrating a defocus amount estimation method according to a first exemplary embodiment of the present invention.

FIG. 13 illustrates an arrangement of marks on the cover glass.

FIG. 14 illustrates the change in evaluation amount with respect to the image plane defocus amount according to a second exemplary embodiment of the present invention.

### DESCRIPTION OF THE EMBODIMENTS

Various exemplary embodiments, features, and aspects of the invention will be described below with reference to the drawings.

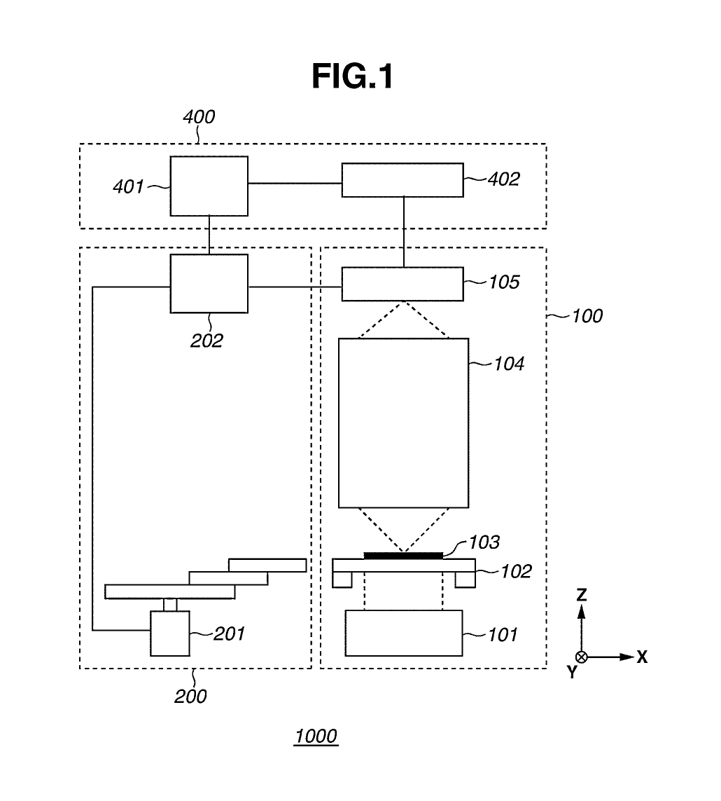

FIG. 1 is a schematic diagram illustrating the configuration of the imaging apparatus (i.e., the virtual slide) according to the present exemplary embodiment. Referring to FIG. 1, an imaging apparatus 1000 includes an imaging unit 100, a control unit 200, and an information processing unit 400. A procedure in which the imaging apparatus 1000 performs imaging of a prepared slide 103 to be observed and acquires the captured image will be described below.

A conveyance unit 201 in the control unit 200 moves the prepared slide 103 onto a stage 102 of the imaging unit 100 according to an instruction from a controller 202. An illumination system 101 illuminates the prepared slide 103 mounted on the stage 102, and the image of the prepared slide 103 is enlarged and formed on an image sensor 105 via an imaging optical system 104. The image sensor 105 then converts the enlarged image of the prepared slide 103 into an electrical signal, and transmits, to the information processing unit 400, the electrical signal as image data. An image processing unit 402 converts, into a digital signal (i.e., a luminance signal), the image data transmitted from the image sensor 105, and performs image processing such as noise reduction and compression. A calculation unit (i.e., a computer) 401 stores the processed digital signal, and performs calculation with respect to the stored captured image. The calculation unit 401 thus estimates the defocus amount and performs image recovery (which will be described in detail below).

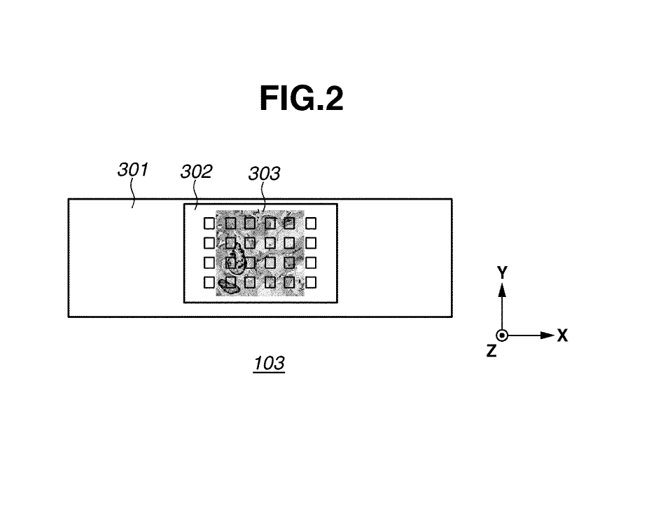

FIG. 2 is a schematic diagram illustrating the configuration of the prepared slide 103 according to the present exemplary embodiment. Referring to FIG. 2, the prepared slide 103 includes a slide glass 301 and a cover glass 302, i.e., transparent members, for fixing a specimen 303 to be observed. A plurality of specific marks is formed in a plane perpendicular to an optical axis of the cover glass 302. The specific marks formed on the cover glass apply, to the transmitted light from the illumination system 101, the phase variation and the amplitude change in a specific distribution (the details of which will be described below). If the specimen 303 and the cover glass 302 cause defocusing to occur when the prepared slide 103 is to be imaged, a blur is generated in the captured image. According to the present exemplary embodiment, the cover glass is used as the transparent member including the specific marks. However, the material of the transparent member is not limited to glass, and may be a plastic film. Further, the specific marks may be formed on the slide glass instead of the cover glass.

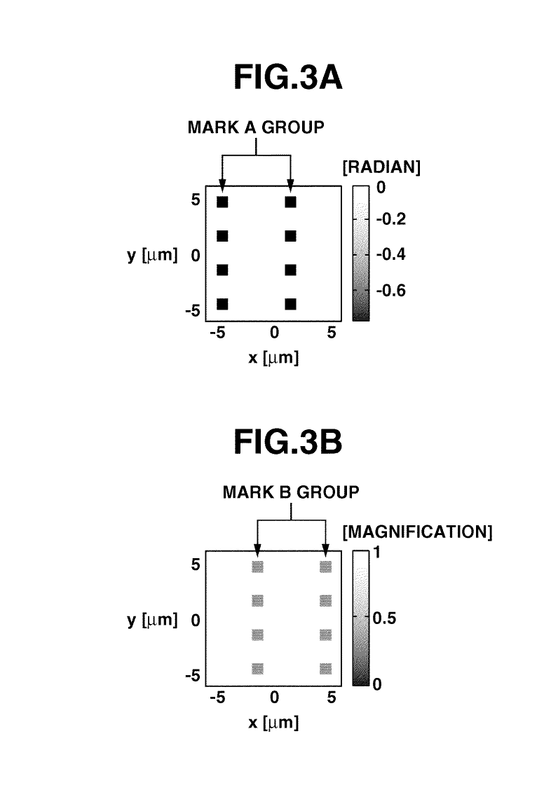

FIG. 3A illustrates the distribution of the phase variation applied by the cover glass 302 to the transmitted light according to the present exemplary embodiment. Referring to FIG. 3A, black squares, each of which is 1 μm on a side, distributed at an interval of 3 μm in a y direction and 6 μm in an x direction, apply, to the transmitted light, the phase variation of −π/4 radian. According to the present exemplary embodiment, when the phase variation applied to the transmitted light is a negative value, the phase variation is generated in the direction towards the prepared slide 103 as seen from the illumination system 101 (i.e., +z direction illustrated in FIG. 1). Further, according to the present exemplary embodiment, each of the squares in the cover glass 302 which apply the phase variation of −π/4 radian is referred to as mark A, and a set of marks A is referred to as a mark A group. Furthermore, referring to FIG. 3A, the area not containing the mark A group (i.e., a white area) does not apply the phase variation to the transmitted light. In other words, the phase variation applied by mark A is an amount of difference from a wavefront which has passed through the area not containing the mark A (i.e., a reference wavefront).

FIG. 3B illustrates the distribution of the amplitude change applied by the cover glass 302 to the transmitted light according to the present exemplary embodiment. Referring to FIG. 3B, gray areas apply, to the transmitted light, the amplitude change by 70%, and absorb incident light. The gray areas are squares, each of which is 1 μm on a side, distributed at an interval of 3 μm in a y direction and 6 μm in an x direction, similarly to the mark A. According to the present exemplary embodiment, the squares in the cover glass 302 which apply the amplitude change by 70% are referred to as mark B, and a set of marks B is referred to as a mark B group. Further, the area illustrated in FIG. 3B not containing the mark B group (i.e., a white area) does not apply the amplitude change to the transmitted light.

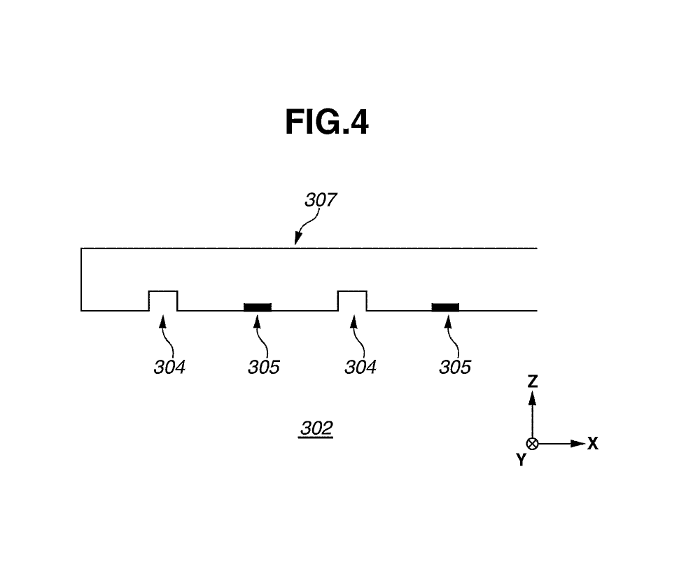

FIG. 4 is a cross-sectional view illustrating the cover glass 302 at positions including mark A and mark B according to the present exemplary embodiment. Referring to FIG. 4, mark A 304 is a square recess, 1 μm on a side, formed on the surface of a glass substrate 307 for applying the negative phase variation (of −π/4 radian) to the transmitted light. The recess is to be filled with the specimen by setting the surface including mark A 304 as the side of the specimen (not illustrated) and fixing the specimen. A depth of the recess is thus determined by refractive indices of the glass substrate 307 and the specimen, a central wavelength of illumination light, and the phase variation to be applied. According to the present exemplary embodiment, if the refractive index of the glass substrate 307 is 1.5 and the refractive index of the specimen is 1.4, the depth of the recess becomes 1.25 times the central wavelength of the illumination light. The recess of mark A 304 can be formed by performing processing such as etching. Further, mark B 305 is a square filter, 1 μm on a side, formed on the surface of the glass substrate 307 for applying the amplitude change to the transmitted light. For example, if an amplitude change by 70% is to be applied to the transmitted light, a filter which attenuates the amplitude of the transmitted light by 30% is arranged. The filter of mark B 305 can be formed by applying a light-absorbing material on the cover glass. A mark which applies both the phase variation and the amplitude change may also be formed on the cover glass.

According to the present exemplary embodiment, the above-described mark A and mark B are alternately arranged in the +x direction at 3 μm intervals on the cover glass. However, relative positions of the mark A group and the mark B group, and the distribution of the respective marks are not limited thereto. For example, mark A and mark B may be respectively arranged at 6 μm intervals in the y direction and 3 μm intervals in the x direction to constitute the mark A group and the mark B group, and the mark A group and the mark B group may be arranged at 3 μm intervals in the +y direction. Further, according to the present exemplary embodiment, mark A and mark B are each arranged at intervals. However, it is not limited thereto. Furthermore, according to the present exemplary embodiment, mark A and mark B are square-shaped, each of which is 1 μm on a side. However, shapes of the marks are not limited thereto, and may be circular or rectangular marks. Moreover, according to the present exemplary embodiment, mark A applies, to the transmitted light, the phase variation of −π/4 radian, and mark B applies, to the transmitted light, the amplitude change by 70%. However, the values are not limited thereto, and the phase variation may be π/2 radian and the amplitude change may be 50%.

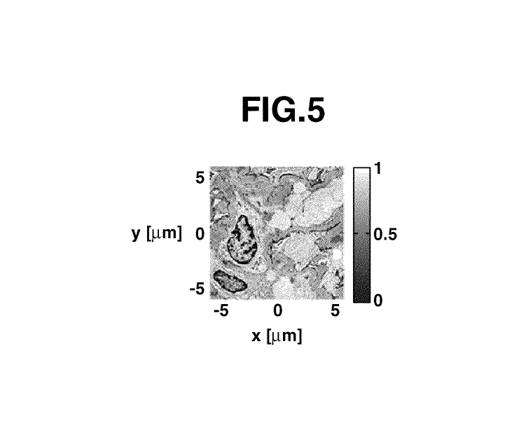

A description about a simulation of the image, which is an image of the prepared slide captured by the imaging unit, will be described below. The prepared slide is prepared by using the cover glass according to the present exemplary embodiment. In the simulation, the intensity transmittance distribution of the specimen is as illustrated in FIG. 5. Further, a numerical aperture and imaging magnification of the imaging optical system are 0.7 and 40 times respectively, and a pixel size and an area aperture ratio of the pixel in the image sensor are 4 μm and 50%, respectively. Furthermore, a partially coherent illumination system is employed with monochromatic light of 550 nm wavelength and coherence factor σ of 0.7. The defocus amount is indicated by an image plane defocus amount, assuming that the imaging plane of the image sensor is the image plane, and the image plane defocus amount becomes a positive value as the image sensor moves away from the imaging optical system.

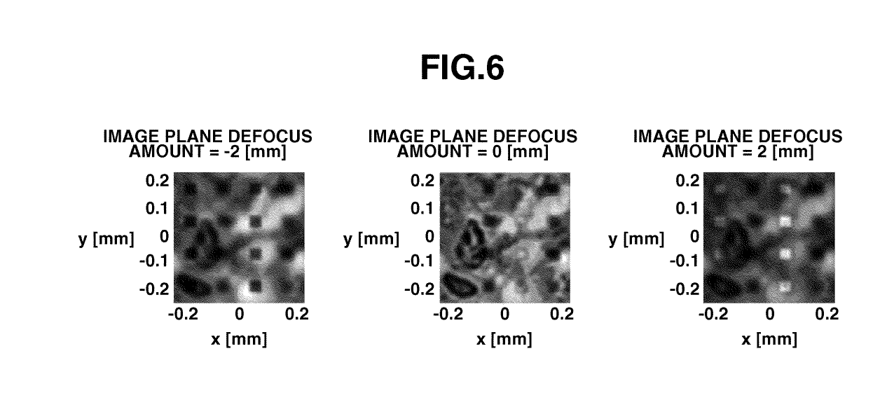

FIG. 6 illustrates a series of captured images (i.e., through-focus images) of the prepared slides, which are output from the imaging unit, when the image plane defocus amount is changed. Referring to FIG. 6, when the image plane defocus amount is 0 mm, the images of the mark B group appear black. As the image plane defocus amount increases, a blur is then symmetrically generated, regardless of whether the image plane defocus amount is a positive value or a negative value. Further, the images of the mark A group appears white as the image plane defocus amount increases in the positive direction, and appears black as the image plane defocus amount increases in the negative direction. There is thus a light-dark change according to the direction of defocusing. In other words, according to the present exemplary embodiment, if the prepared slide is formed using the cover glass, there is an asymmetrical change in the image of mark A and a symmetrical change in the image of mark B according to whether the image plane defocus amount changes in the positive or the negative direction.

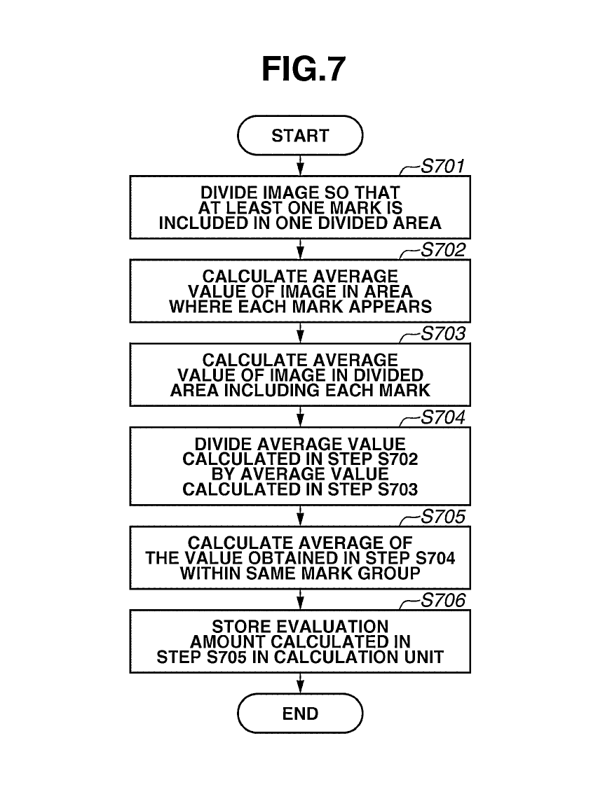

The method for calculating an evaluation amount for estimating the image plane defocus amount from the image acquired by the imaging unit (i.e., an evaluation amount calculation process) will be described below with reference to the flowchart illustrated in FIG. 7. The processes performed in each of the steps in the flowchart are performed by the calculation unit in the imaging apparatus unless otherwise stated.

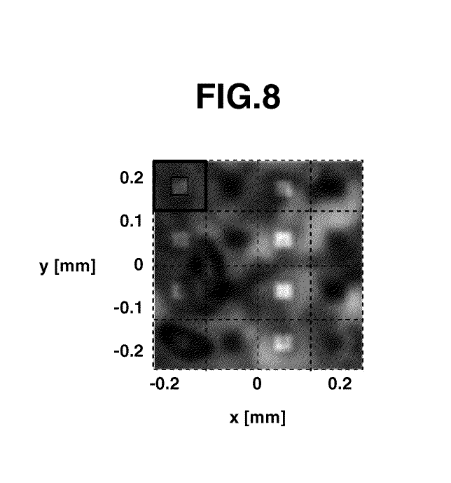

In step S701 (i.e., a division process), the calculation unit divides the image so that a divided area includes at least one of mark A and mark B, to extract the respective image change of mark A and mark B. According to the present exemplary embodiment, the marks are arranged at regular intervals on the cover glass as described above. It is thus desirable to equally divide the image as indicated by broken lines illustrated in FIG. 8, so that one mark is arranged at the center of the divided area.

In step S702 (i.e. a first averaging process), the calculation unit calculates an average value of the image within the area in which the image of the mark appears (i.e., within thin solid lines illustrated in FIG. 8). The calculated value indicates the change in the mark with respect to the image plane defocus amount. However, since the prepared slide is configured by laying the cover glass on the specimen, if there is a difference in the transmittance of the specimen among each of the divided areas, the value acquired in step S702 becomes different among each of the divided areas. To solve such a problem, in step S703 (i.e., a second averaging process), the calculation unit calculates an average value of the image within the divided area including the image of the mark (i.e., within bold solid lines illustrated in FIG. 8). The calculated value corresponds to the transmittance of the specimen within the divided area. In step S704 (i.e., a division process), the calculation unit divides the value obtained in step S702 by the value obtained in step S703, and thus removes the difference in the transmittance of the specimen among the divided areas. The above-described processes in step S702 to step S704 are performed on each divided area.

However, if there is a distribution in the transmittance of the specimen within each divided area, the value obtained in step S704 becomes different for each divided area. To solve such a problem, in step S705 (i.e., a third averaging process), the calculation unit averages the value obtained in step S704 among the same mark group (i.e., each of mark group A and mark group B). As a result, the calculation unit calculates the value in which the effect of the transmittance distribution of the specimen in each divided area has been reduced. The value obtained as above with respect to the mark A group is thus set as an evaluation amount 1, and the value obtained with respect to the mark B group is set as an evaluation amount 2. In step S706, the calculation unit stores each evaluation value.

According to the present exemplary embodiment, by performing the above-described evaluation amount calculation process, the evaluation values can be calculated from the captured image of the prepared slide including the cover glass and the specimen. According to the present exemplary embodiment, the evaluation value calculation process has been described, assuming the case where the evaluation value is calculated with respect to the captured image of the prepared slide. However, the evaluation amount calculation process may be applied to the image acquired by imaging only the cover glass (i.e., the reference image) without previously placing the specimen. In other words, only the cover glass is previously imaged before preparing the prepared slide, and the evaluation amount calculation process is then performed on the acquired reference image. The evaluation value thereof can thus be stored in the calculation unit (the process will be described in detail below).

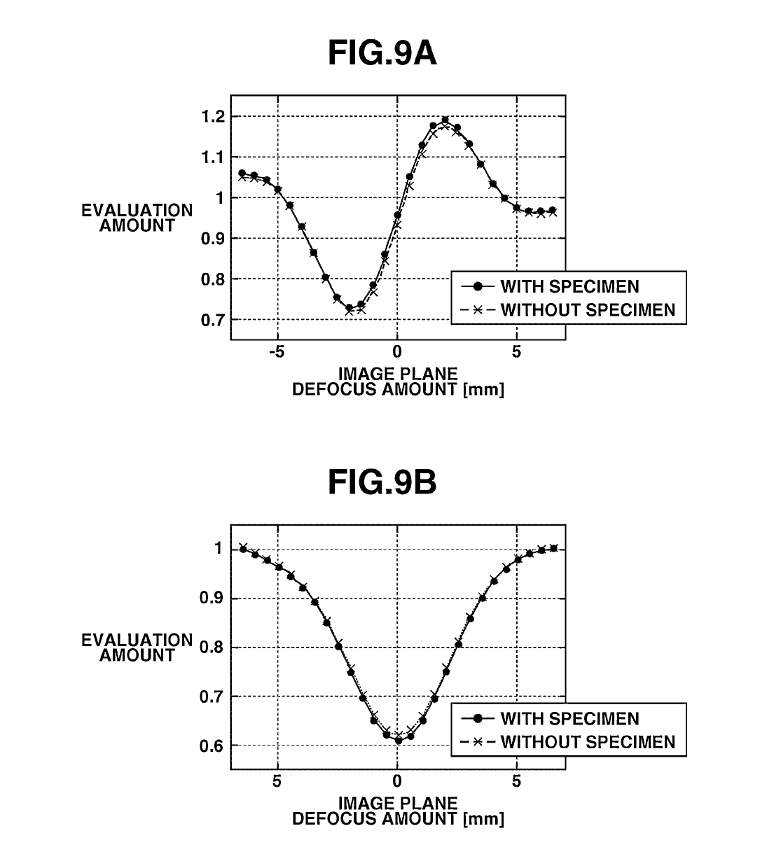

FIG. 9A illustrates the change in the evaluation amount 1, and FIG. 9B illustrates the change in the evaluation amount 2, with respect to the image plane defocus amount. Referring to FIGS. 9A and 9B, the solid line indicates the evaluation value with respect to the captured image of the prepared slide with the specimen, and the broken line indicates the evaluation value with respect to the reference image of only the cover glass without the specimen. In both FIGS. 9A and 9B, the solid line and the broken line similarly change. It can thus be recognized that the evaluation amount 1 and the evaluation amount 2 are fixed values with respect to the image plane defocus amount regardless of whether the specimen is included. In other words, if the evaluation value of the reference image is previously acquired for a plurality of defocus amounts, the image defocus amount can be estimated by comparing the acquired plurality of evaluation values with the evaluation value of the captured image.

In FIG. 9B, the evaluation amount 2 symmetrically changes with respect to the change in the image plane defocus amount. In other words, the value of the evaluation amount is determined according to an absolute value of the image plane defocus amount, so that the absolute value of the image plane defocus amount can be estimated by calculating the evaluation amount 2. Further, in FIG. 9A, the evaluation amount 1 asymmetrically changes with respect to the change in the image plane defocus amount from the positive direction to the negative direction. In other words, whether the absolute value of the image plane defocus amount obtained using the evaluation amount 2 is actually a positive value or a negative value can be determined employing the evaluation amount 1.

As described above, according to the present exemplary embodiment, the cover glass including the specific marks is employed, so that the image plane defocus amount caused by the specimen to be observed or the cover glass can be estimated. In such a case, as illustrated in FIG. 6, the captured image obtained by capturing the image of the prepared slide contains both the image of the specimen and the image of the marks on the cover glass. If the captured image obtained for estimating the image plane defocus amount is to be used in pathological diagnosis, the image containing the marks on the cover glass is not desirable for use in the diagnosis. To solve such a problem, the effect of the cover glass is removed from the captured image of the prepared slide by performing the image recovery process to be described below.

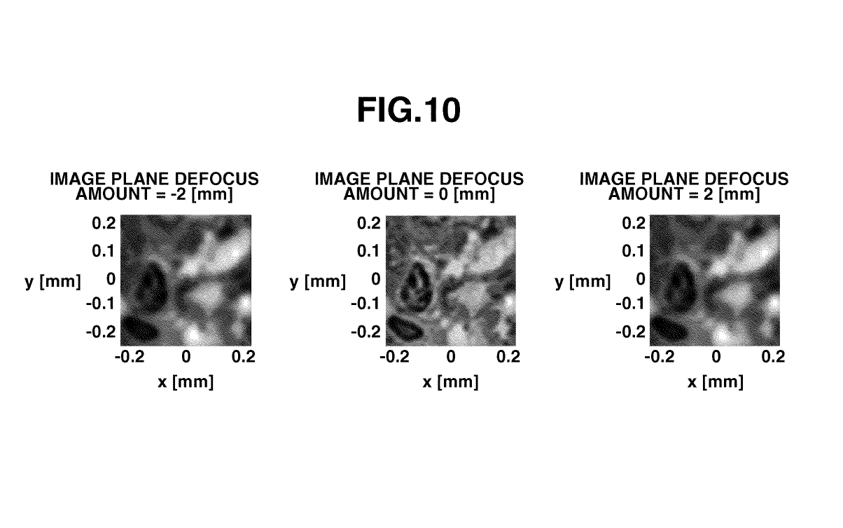

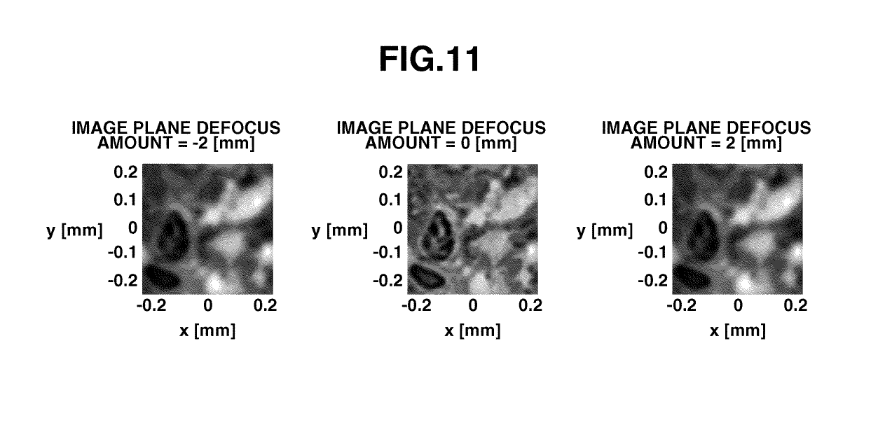

The evaluation amount 1 and the evaluation amount 2 are used to estimate the image plane defocus amount from the captured image of the prepared slide. The image among the plurality of reference images (i.e., the through-focus images of the cover glass) previously stored in the calculation unit, which corresponds to the estimated image plane defocus amount, is then read. The captured image of the prepared slide is thus divided by the read reference image of the cover glass. FIG. 10 illustrates the processing results acquired by performing the image recovery process, and the marks on the cover glass appearing in the images illustrated in FIG. 6 do not appear in FIG. 10. FIG. 11 illustrates the through-focus images of the prepared slide using the conventional cover glass that does not include the marks as in the present exemplary embodiment. If the images illustrated in FIG. 10 are compared with the images illustrated in FIG. 11, there is no visible difference between the images. The effect of the cover glass can thus be removed from the captured image of the prepared slide by using the previously obtained reference image of the cover glass.

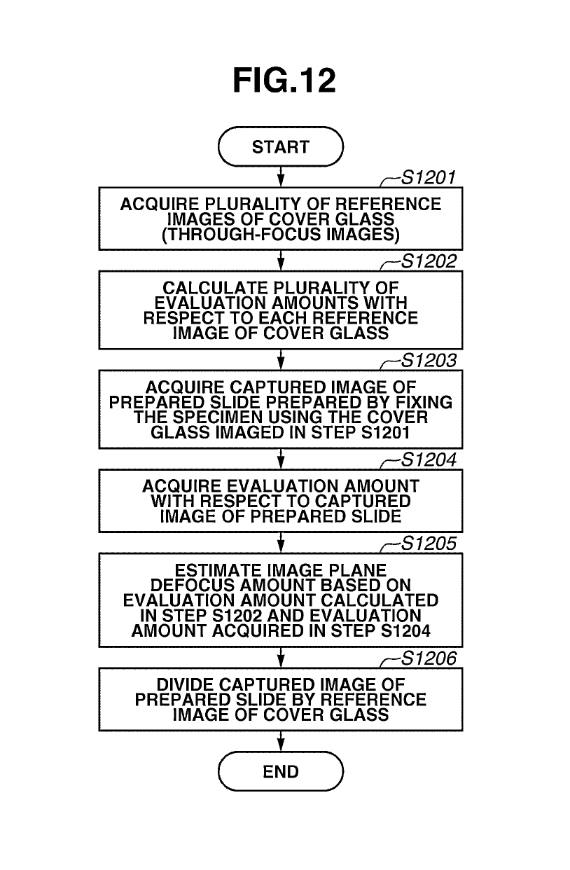

The method for estimating the defocus amount according to the first exemplary embodiment will be described below with reference to the flowchart illustrated in FIG. 12. The processes performed in each of the steps in the flowchart are performed by the calculation unit in the imaging apparatus unless otherwise stated. Further, simulation is performed under the same conditions as described above.

In step S1201, the imaging unit images the cover glass according to the present exemplary embodiment with respect to a plurality of defocus amounts, and the calculation unit stores the acquired plurality of reference images (i.e., through-focus images). According to the present exemplary embodiment, the defocus amount is changed when performing imaging by vertically-driving the image sensor in the optical axis direction of the imaging optical system. However, the defocus amount may also be changed by driving the stage on which the prepared slide is mounted.

In step S1202, the calculation unit calculates the evaluation amount 1 and the evaluation amount 2 with respect to each of the plurality of reference images acquired in step S1201, according to the evaluation amount calculation process illustrated in FIG. 7. The calculation unit then stores the calculated evaluation amount 1 and evaluation amount 2 associated with each image plane defocus amount. The evaluation amount 1 and the evaluation amount 2 are the same values as the values of “without specimen” indicated by the broken line illustrated in FIGS. 9A and 9B. The plurality of reference images acquired in step S1201 and each of the evaluation amounts calculated in step S1202 can be set as reference data. The reference data can then be used in estimating the image plane defocus amount when imaging the prepared slide including the specimen to be observed, and in performing image recovery. It is not necessary to obtain the reference data each time the image of the specimen to be observed is captured, as long as the reference data is once obtained when starting the estimation of the image plane defocus amount. The processes of step S1201 and step S1202 are collectively referred to as a reference image evaluation step.

In step S1203, the specimen to be observed is fixed by the cover glass which has been imaged in the reference image evaluation step (S1201). The calculation unit then obtains and stores the captured image of the prepared slide that has been prepared. In step S1204, the calculation unit calculates the evaluation amount 1 and the evaluation amount 2 from the captured image of the prepared slide obtained in step S1203, according to the evaluation amount calculation process illustrated in FIG. 7. The processes of step S1203 and step S1204 are collectively referred to as a captured image evaluation step.

In step S1205 (i.e., an estimation step), the calculation unit compares each evaluation amount acquired in the captured image evaluation step (step S1204) with the reference data stored in the reference image evaluation step (S1202). The calculation unit then estimates the image plane defocus amount. For example, it is assumed that the values of the evaluation amount 1 and the evaluation amount 2 are respectively obtained as 1.13 and 0.858 from the acquired captured image of the prepared slide. If the values are compared with the reference data previously stored in the calculation unit, it can be estimated from the evaluation amount 2 that the image plane defocus amount is proximately ±3 mm. Further, since the evaluation amount 1 is a positive value, it can be estimated that the image plane defocus amount is +3 mm. The estimation method performed in the estimation step (S1205) is not limited to the above-described method. For example, if it is estimated from the evaluation amount 1 that the image plane defocus amount is 1 mm or 3 mm, it may be estimated from the evaluation amount 2 that 3 mm among the two estimation values is more appropriate. Further, other values obtained by calculating the evaluation amount 1 and the evaluation amount 2 may be used as the evaluation amount.

After estimating the image plane defocus amount, in step S1206 (i.e., an image recovery step), the calculation unit performs image recovery. More specifically, the calculation unit reads, among the plurality of reference images of the cover glass acquired in the reference image evaluation step (S1201), the image corresponding to the image plane defocus amount estimated in the estimation step (S1205). The calculation unit then divides the captured image of the prepared slide by the read reference image. As a result, the effect of the cover glass can be removed from the captured image, so that the captured image acquired for estimating the image plane defocus amount can be used in performing pathological diagnosis.

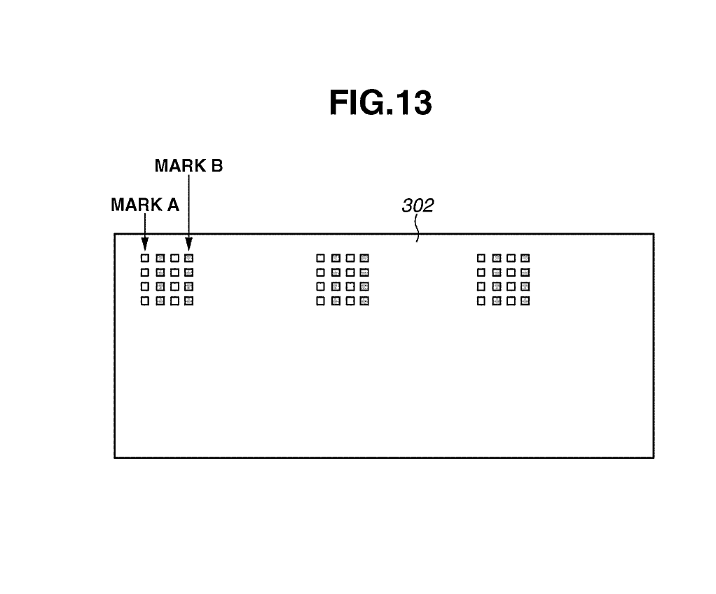

As described above, by performing the image plane defocus amount estimation method according to the present exemplary embodiment, the image plane defocus amount in the imaging position of the prepared slide can be estimated. Further, the image of the prepared slide in which the effect of the cover glass has been removed can be acquired. Furthermore, by performing the image plane defocus amount estimation method at each imaging position of the specimen, the image defocus amount distribution in the entire observation area of the specimen can be acquired. FIG. 13 illustrates an example of an arrangement of the marks on the cover glass used in the above-described case. If the process illustrated in FIG. 12 is performed on each of the mark groups illustrated in FIG. 13, the image plane defocus amount in the observation area in which each mark group is arranged, and the image of the prepared slide can be acquired. Referring to FIG. 13, a plurality of mark groups, each including eight marks A and eight marks B, is regularly-arranged on the cover glass. However, the number of marks and the arrangement are not limited thereto, and may be determined according to the observation area in which the image plane defocus amount is to be estimated.

The image plane defocus amount estimation method according to a second exemplary embodiment of the present invention will be described below.

According to the first exemplary embodiment, the image plane defocus amount is estimated by performing comparison with the reference data acquired by previously imaging the cover glass. However, it is not necessary to acquire the reference data only for determining whether the defocusing direction is in the positive direction or the negative direction. In other words, the defocusing direction can be determined based on whether the images of mark A in the captured image of the prepared slide appear light or dark. For example, if the images of mark A appear bright (i.e., appear white) as compared to the surroundings, it can be determined that the defocusing direction is in the positive direction.

Further, according to the first exemplary embodiment, the cover glass applies, to the transmitted light, the negative phase variation and the amplitude change. However, the image plane defocus amount can be estimated using the cover glass which applies only the phase variation. In such a case, the cover glass only needs to include mark A and does not need to include the filter (i.e., mark B) to be arranged for applying the amplitude change, so that manufacturing becomes easy. However, if such a cover glass is used, only the evaluation amount 1 is obtained, and the range in which the image plane defocus amount can be estimated becomes limited. For example, according to the simulation result of the present exemplary embodiment, if the image plane defocus amount is within the range between −2 mm and 2 mm, the image plane defocus amount can be estimated only using the evaluation amount 1. Further, normalization may be performed by a value calculated as follows, to express the amounts in a unit referred to as a Rayleigh unit which does not depend on the imaging optical system. wavelength×the square of magnification/the square of numerical aperture/2

As a result, estimation can be performed in the range between −2.24 and 2.24. In the case where the cover glass which only applies the phase variation is used, the effect of the cover glass can also be removed by dividing the captured image of the prepared slide by the previously stored reference image of the cover glass.

On the other hand, the image plane defocus amount can be estimated using the cover glass which only applies the amplitude change. In such a case, the cover glass only needs to include mark B and does not need to include the recess (i.e., mark A) for applying the phase variation, so that manufacturing becomes easy. However, if such a cover glass is used, the value that can be estimated is only the absolute value of the image plane defocus amount.

Furthermore, a mark which applies a positive phase variation may be arranged on the cover glass in addition to the mark that applies the negative phase variation and the amplitude change to the transmitted light. If the mark which applies the positive phase variation is arranged on the cover glass as mark C, the image of the mark C in the through-focus image of the cover glass indicates a light-dark change according to the defocusing direction. Since the light-dark change of the image of the mark C is opposite to the light-dark change of the image of mark A, one of the marks always appears white regardless of the defocusing direction. In other words, if mark C is added, it becomes easy to visibly distinguish the change in the through-focus image. This can prevent the image of the mark A from being mistakenly recognized as the image of mark B that applies the amplitude change when estimating the image plane defocus amount.

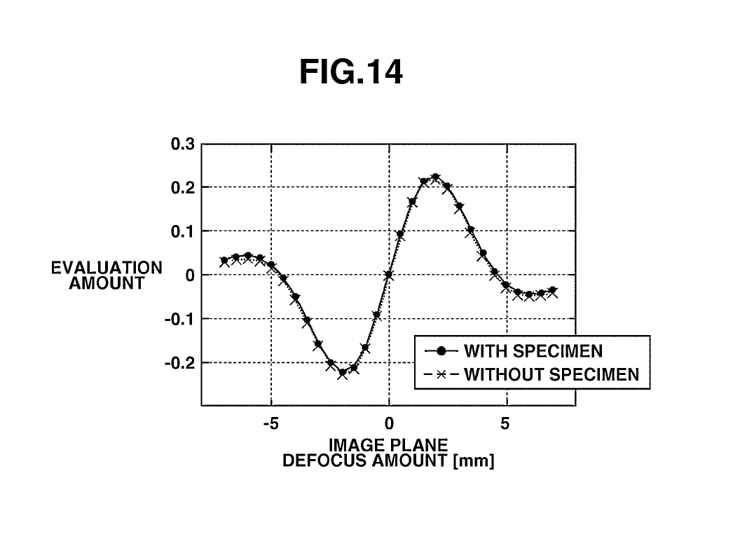

Moreover, an evaluation amount 3 can be newly acquired by obtaining the difference between the evaluation amount 1 obtained from mark A and the evaluation amount 1 obtained from mark C. For example, FIG. 14 illustrates the evaluation amount 3 in the case where mark C which applies the phase variation of π/4 radian is arranged on the cover glass along with mark A that applies the phase variation of −π/4 radian and mark B that applies the amplitude change by 70%. The evaluation amount 3 is asymmetrical with respect to the change in the image plane defocus amount, similarly as the evaluation amount 1 with respect to mark A. The evaluation amount 3 can thus be used in determining focusing and whether the image plane defocus amount is a positive value or a negative value. Referring to FIG. 9A, when the image plane defocus amount is 0, i.e., when the image plane is in a best focus position, the value of the evaluation amount 1 is 0.93. The vales cannot be specified without reference data. In contrast, the value of the evaluation amount 3 is 0 when the image plane is in the best focus position, so that whether defocusing has occurred can be more accurately determined as compared to the evaluation amount 1 when there is no reference data. Further, if the evaluation amount 3 and the evaluation amount 2 are combined, the image plane defocus amount can be similarly acquired as when using the evaluation amount 1. As described above, when mark C which applies the positive phase variation is arranged, the effect of the cover glass can be removed by dividing the captured image of the prepared slide by the reference image of the cover glass.

According to the above-described exemplary embodiment, the image recovery process for removing the effect of the cover glass is performed by division using the previously-acquired reference image of the cover glass. However, the method for calculating the image is not limited thereto. For example, the effect of the cover glass can be removed by subtracting the previously-acquired reference image of the cover glass from the captured image of the prepared slide.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-130104 filed Jun. 7, 2012, which is hereby incorporated by reference herein in its entirety.

What is claimed is:

1. A defocus amount estimation method for an imaging apparatus that captures, using an image sensor, an image of a specimen formed by an imaging optical system, the defocus amount estimation method comprising:
a captured image evaluation step of fixing the specimen using a transparent member including a mark that applies at least one of a phase variation and an amplitude change to transmitted light, to acquire a captured image containing an image of the specimen and an image of the mark; and
an estimation step of estimating a defocus amount based on the captured image.

2. The defocus amount estimation method according to claim 1, further comprising, before the captured image evaluation step, a reference image evaluation step of capturing an image of the transparent member to acquire a plurality of reference images not including the image of the specimen,
wherein the estimation step includes estimating the defocus amount based on the captured image and the reference image.

3. The defocus amount estimation method according to claim 2, wherein the reference image evaluation step and the captured image evaluation step include an evaluation amount calculation process, the evaluation amount calculation process comprising:
dividing an image acquired by the imaging apparatus into a plurality of divided areas, each of which includes an image of the mark;
performing first averaging to calculate an average value of each of images of marks included in the plurality of divided areas;
performing second averaging to calculate an average value of each of images in each of the plurality of divided areas;
performing division by dividing each average value calculated in the first averaging by each average value calculated in the second averaging; and
performing third averaging to calculate an evaluation amount by averaging a value acquired by performing the division, among divided areas including a same mark in the plurality of divided areas.

4. The defocus amount estimation method according to claim 3, wherein the estimation step includes estimating the defocus amount based on a plurality of evaluation amounts calculated from the plurality of reference images through the evaluation amount calculation process in the reference image evaluation step, and an evaluation amount calculated from the captured image through the evaluation amount calculation process in the captured image evaluation step.

5. The defocus amount estimation method according to claim 2, further comprising, after the estimation step, an image recovery step of removing the image of the mark from the captured image by performing calculation on the captured image and the reference image.

6. The defocus amount estimation method according to claim 1, wherein the transparent member includes another mark, the another mark applies:
another phase variation to transmitted light if the mark applies the amplitude change to transmitted light; and
another amplitude change to transmitted light if the mark applies the phase change to transmitted light.

7. An imaging apparatus comprising:
an imaging optical system configured to form an image of a specimen;
an image sensor configured to capture an image of the specimen via the imaging optical system; and
a calculation unit configured to estimate a defocus amount in the imaging apparatus,
wherein the specimen is fixed by a transparent member including a mark that applies at least one of a phase variation and an amplitude change to transmitted light, and
wherein the calculation unit estimates a defocus amount based on a captured image containing the image of the specimen and an image of the mark.

8. The imaging apparatus according to claim 7, wherein the transparent member includes another mark, the another mark applies:
another phase variation to transmitted light if the mark applies the amplitude change to transmitted light; and
another amplitude change to transmitted light if the mark applies the phase change to transmitted light.

9. A transparent member for fixing a specimen to be observed by an imaging apparatus, the transparent member comprising a mark configured to apply, to transmitted light, a phase variation and an amplitude change in a plane perpendicular to an optical axis of the transparent member.

10. The transparent member according to claim 9, further comprising another mark, the another mark applies:
another phase variation to transmitted light if the mark applies the amplitude change to transmitted light; and
another amplitude change to transmitted light if the mark applies the phase change to transmitted light.
